(19) United States
(12) Patent Application Publication
(10) Pub. No.: US 2026/0027919 A1
(43) Pub. Date: Jan. 29, 2026

(54) FUEL CELL VEHICLE

(71) Applicants: HYUNDAI MOTOR COMPANY, Seoul (KR); KIA CORPORATION, Seoul (KR)

(72) Inventor: Gyeong Eun Lee, Hwaseong-si (KR)

(73) Assignees: HYUNDAI MOTOR COMPANY, Seoul (KR); KIA CORPORATION, Seoul (KR)

(21) Appl. No.: 19/052,387

(22) Filed: Feb. 13, 2025

(30) Foreign Application Priority Data
Jul. 29, 2024 (KR) 10-2024-0100213

(51) Int. Cl. B60L 50/75; B60K 1/02; B60K 1/04; B60K 15/03; B60K 15/063; B62D 21/15; H01M 8/04082; H01M 16/00; H01M 50/249

(52) U.S. Cl. CPC B60L 50/75; B60K 1/02; B60K 1/04; B60K 15/063; B62D 21/152; H01M 8/04201; H01M 16/006; H01M 50/249; B60K 2001/0438; B60K 2015/03315; B60K 2015/0634; H01M 2220/20; H01M 2250/20; H01M 2250/402

(57) ABSTRACT

Disclosed is a fuel cell vehicle capable of using an electric vehicle-dedicated platform. The fuel cell vehicle includes a fuel cell unit, a hydrogen tank, and a battery disposed in a hydrogen area located between front wheels and rear wheels, and includes a frame coupled to a vehicle body and configured to allow the fuel cell unit, the hydrogen tank, and the battery to be mounted thereto.

This application claims the benefit of Korean Patent Application No. 10-2024-0100213, filed on Jul. 29, 2024, which is hereby incorporated by reference as if fully set forth herein.

### TECHNICAL FIELD

Example embodiments relate to a fuel cell vehicle.

### BACKGROUND

Recently, as traditional internal combustion engine vehicles are replaced with electric vehicles, automakers have focused on the development of electric vehicle-dedicated platforms. Compared to platforms for internal combustion engine vehicles, platforms for electric vehicles provide for a reduced engine compartment size because a power electric (PE) system (including a motor, a reducer, and an inverter) corresponding to an engine and a transmission has a relatively small volume and the number of related parts is relatively small. Due to reduction in the size of the engine compartment in an electric vehicle, the size of the passenger compartment of the platform for electric vehicles may increase, and accordingly, marketability thereof may be improved. In most electric vehicles, a high-voltage battery, which may be heavy, is used. The battery may be disposed below passenger seats, which in turn may provide a low center of gravity of the vehicle, and thus may provide better driving stability. Therefore, automakers are motivated to use electric vehicle-dedicated platforms.

### SUMMARY

Accordingly, embodiments herein are directed to a fuel cell vehicle that substantially address one or more problems due to current limitations and disadvantages.

Embodiments herein provide a fuel cell vehicle capable of using an electric vehicle-dedicated platform.

The example embodiments are not limited to the above-mentioned objects, and other objects not mentioned herein will be provided from the following description.

Additional objects and features of the disclosure will be set forth at least in part in the description herein and in part from examination of the following or may be learned from practice of the disclosure. The objectives of the disclosure may be provided in the written description and claims hereof as well as the appended drawings.

A fuel cell vehicle according to an example embodiment may include a fuel cell unit, a hydrogen tank, and a battery provided (e.g., disposed) in a hydrogen area located between front wheels and rear wheels, and may include a frame coupled to a vehicle body and configured to allow the fuel cell unit, the hydrogen tank, and the battery to be mounted thereto.

In an example embodiment, the fuel cell unit, the hydrogen tank, and the battery may be provided (e.g., disposed) above a ramp angle line.

In an example embodiment, the fuel cell vehicle may further include an under-cover provided (e.g., disposed) below the fuel cell unit, the hydrogen tank, and the battery.

In an example embodiment, the fuel cell unit, the hydrogen tank, and the battery may be modularized with the frame to form a frame module, and the frame module may be (e.g., integrally) coupled to the vehicle body.

In an example embodiment, at least a portion of the hydrogen area may overlap an indoor space or a cargo loading space of the vehicle in a vertical direction.

In an example embodiment, the frame may include a framework having formed therein first and second through-holes adjacent to each other in a first direction in which the vehicle travels. At least a portion of the fuel cell unit may be located in the first through-hole, and at least a portion of the hydrogen tank and at least a portion of the battery may overlap the second through-hole in a second direction intersecting the first direction.

In an example embodiment, the fuel cell vehicle may further include a first fixing part configured to couple or fix the framework to the vehicle body and a second fixing part configured to couple or fix the fuel cell unit, the hydrogen tank, and the battery to the framework.

In an example embodiment, the hydrogen area may be located between a front-wheel suspension and a rear-wheel suspension.

In an example embodiment, the hydrogen area may be provided (e.g., disposed) between a front-wheel power electric (PE) part and a rear-wheel PE part.

In an example embodiment, the front-wheel suspension and the framework may be provided (e.g., disposed) so as to be spaced apart from each other by a distance greater than a forward collision push-back distance in the first direction, and the forward collision push-back distance may correspond to a movement distance of the front-wheel suspension and the front-wheel PE part in the event of vehicle collision.

In an example embodiment, the rear-wheel suspension and the framework may be provided (e.g., disposed) so as to be spaced apart from each other by a distance greater than a rear collision push-back distance in the first direction, and the rear collision push-back distance may correspond to a movement distance of the rear-wheel suspension and the rear-wheel PE part in the event of vehicle collision.

In an example embodiment, the first through-hole may be located closer to a front side of the vehicle than the second through-hole.

In an example embodiment, the fuel cell vehicle may further include a pair of side members extending in the first direction and facing each other in a third direction intersecting each of the first direction and the second direction, and the fuel cell unit may include an upper portion located between the pair of side members and a lower portion located beneath the upper portion and having a larger width in the third direction than the upper portion.

In an example embodiment, the hydrogen tank may be provided (e.g., disposed) above the battery, or the battery may be provided (e.g., disposed) above the hydrogen tank.

In an example embodiment, at least a portion of one of the hydrogen tank and the battery may be provided (e.g., disposed) between the pair of side members, the remaining one of the hydrogen tank and the battery may be provided (e.g., disposed) below one of the hydrogen tank and the battery, and a width of one of the hydrogen tank and the battery in the third direction may be smaller than a width of the remaining one of the hydrogen tank and the battery in the third direction.

In an example embodiment, a length of at least a portion of one of the hydrogen tank and the battery in the third direction may be less than a spacing distance between the pair of side members in the third direction.

In an example embodiment, a length of the remaining one of the hydrogen tank and the battery in the third direction may be greater than a spacing distance between the pair of side members in the third direction and less than a spacing distance between a pair of side sills in the third direction.

The description of the present disclosure is exemplary and may provide explanation of the disclosure as claimed.

### BRIEF DESCRIPTION OF THE DRAWINGS

The accompanying drawings may provide an understanding of the disclosure and are incorporated herein, illustrate embodiment(s) of the disclosure, and together with the description provide the disclosure. In the drawings:

FIG. 1 is a schematic side view of a fuel cell vehicle according to an example embodiment;

FIG. 2 is a plan view of the fuel cell vehicle shown in FIG. 1;

FIG. 3A is a cross-sectional view taken along line I-I′ shown in FIG. 2;

FIG. 3B is a cross-sectional view taken along line II-II′ shown in FIG. 2;

FIG. 3C is a cross-sectional view taken along line III-III′ shown in FIG. 2;

FIG. 4A is an exploded perspective view of a fuel cell unit, a hydrogen tank, and a battery;

FIG. 4B is a coupled perspective view of the fuel cell unit, the hydrogen tank, and the battery;

FIG. 5A is a bottom perspective view of a vehicle body and a frame module before the vehicle body and the frame module are coupled to each other;

FIG. 5B is a top perspective view of the vehicle body and the frame module before the vehicle body and the frame module are coupled to each other;

FIG. 6A is a coupled perspective view of a frame and the vehicle body according to an example embodiment;

FIG. 6B is a coupled cross-sectional view of the battery and the frame according to an example embodiment;

FIG. 7A is a bottom view of an example embodiment of the fuel cell vehicle shown in FIG. 1;

FIG. 7B is a bottom view of another embodiment of the fuel cell vehicle shown in FIG. 1;

FIG. 7C is a bottom view of still another embodiment of the fuel cell vehicle shown in FIG. 1; and

FIG. 7D is a bottom view of yet another embodiment of the fuel cell vehicle shown in FIG. 1.

### DETAILED DESCRIPTION

The present disclosure is described more fully hereinafter with reference to the accompanying drawings, in which various embodiments are shown. The examples, however, may be embodied in different forms, and should not be construed as being limited to the example embodiments set forth herein. Rather, the embodiments are provided to convey the scope of the disclosure.

When an element is referred to as being “on” or “under” another element, the element may be (e.g., directly) on/under the element, or one or more intervening elements may also be present.

When an element is referred to as being “on” or “under,” “under the element” as well as “on the element” may be included based on the element.

In addition, relational terms, such as “first”, “second”, “on/upper part/above”, and “under/lower part/below”, are used (e.g., only) to distinguish between one subject or element and another subject or element, without (e.g., requiring or) involving any physical or logical relationship or sequence between the subjects or elements.

Herein, a fuel cell vehicle 100 according to an example embodiment will be described with reference to the accompanying drawings. The fuel cell vehicle 100 will be described using the Cartesian coordinate system (x-axis, y-axis, z-axis) for convenience of the description, but may also be described using other coordinate systems. In the Cartesian coordinate system, the x-axis, the y-axis, and the z-axis are perpendicular to each other, but the example embodiments are not limited thereto. Thus, the x-axis, the y-axis, and the z-axis may intersect each other obliquely.

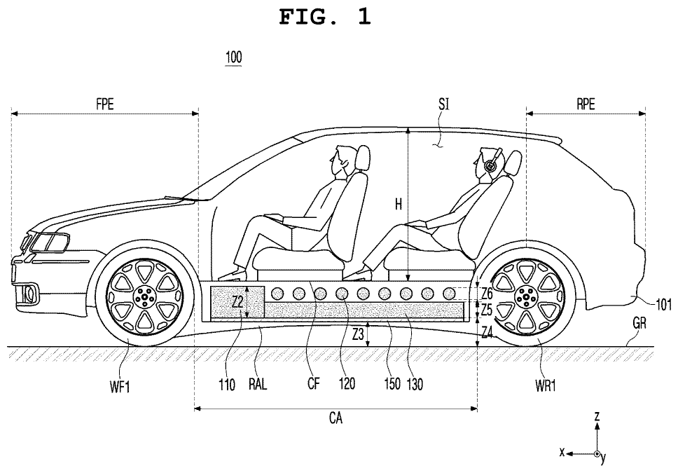

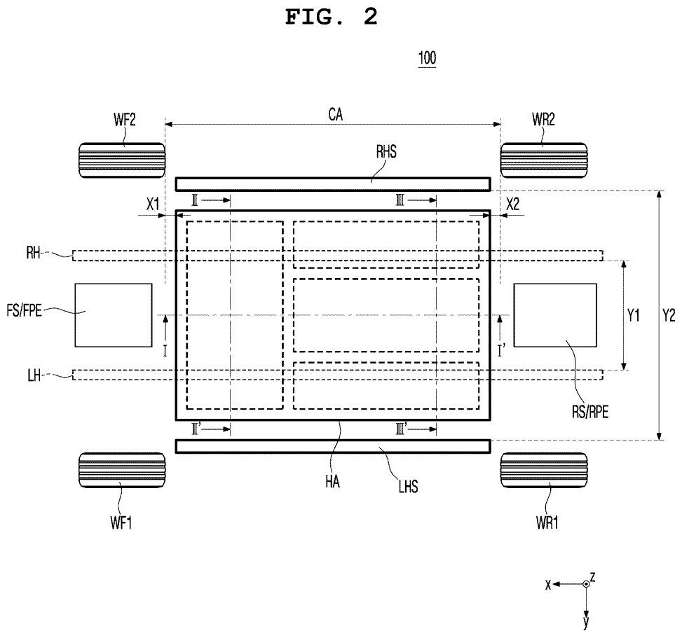

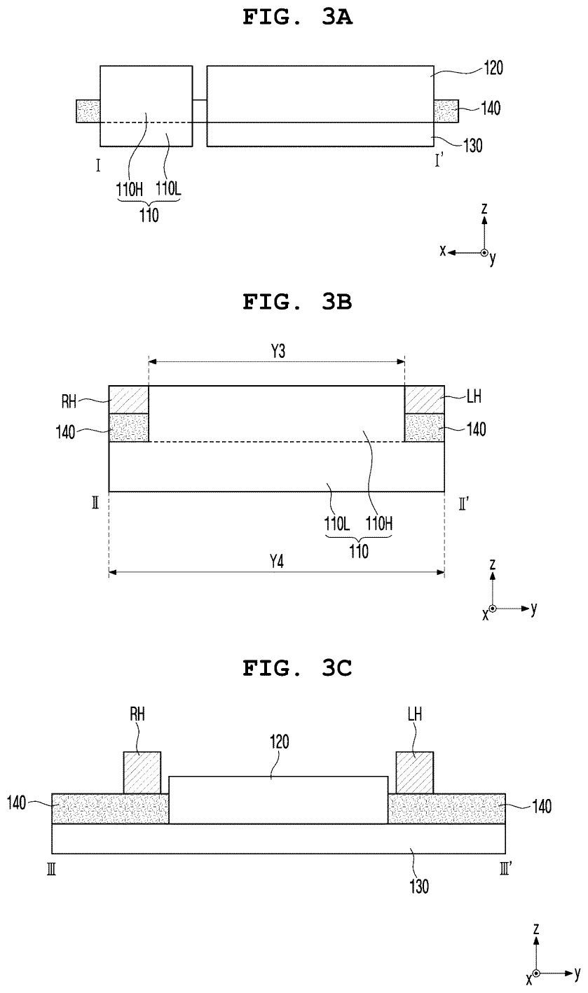

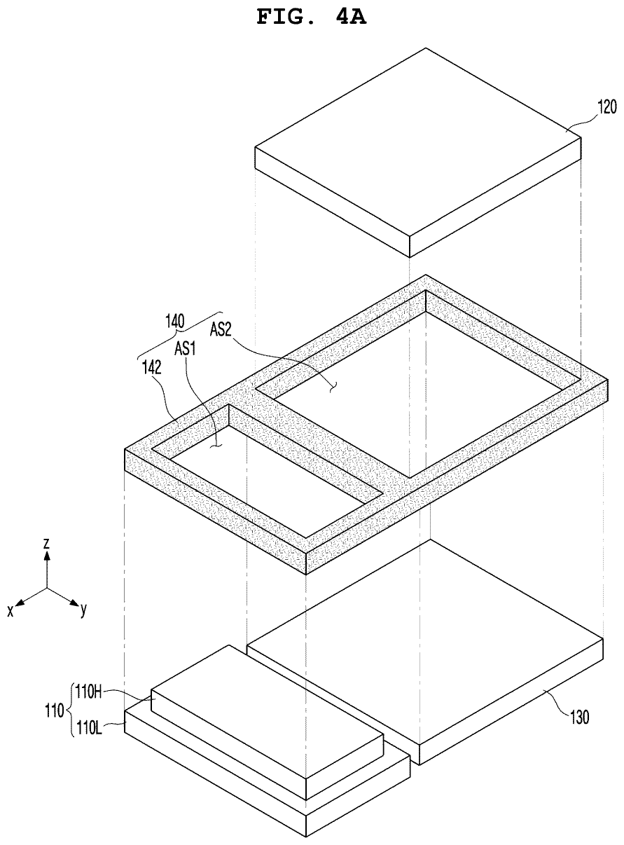

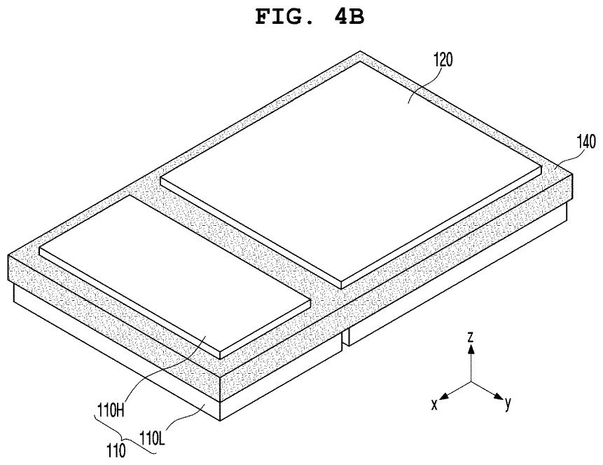

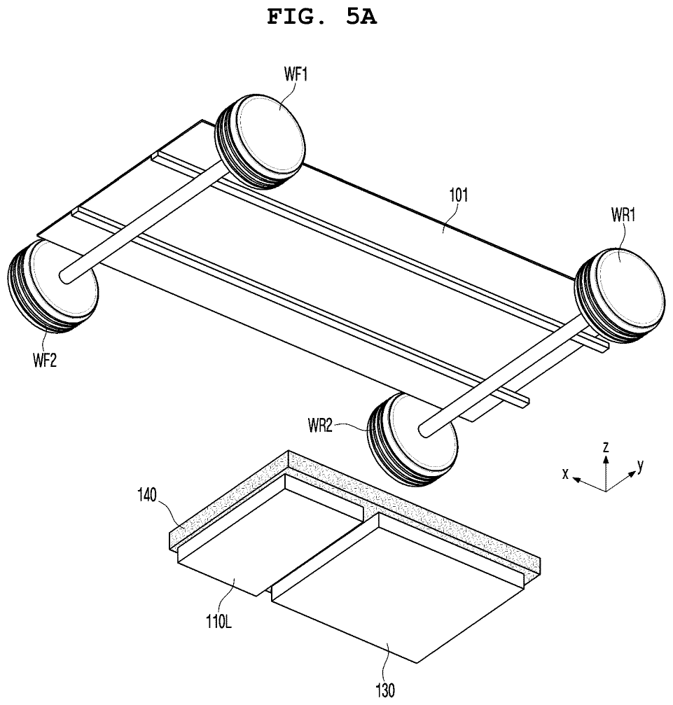

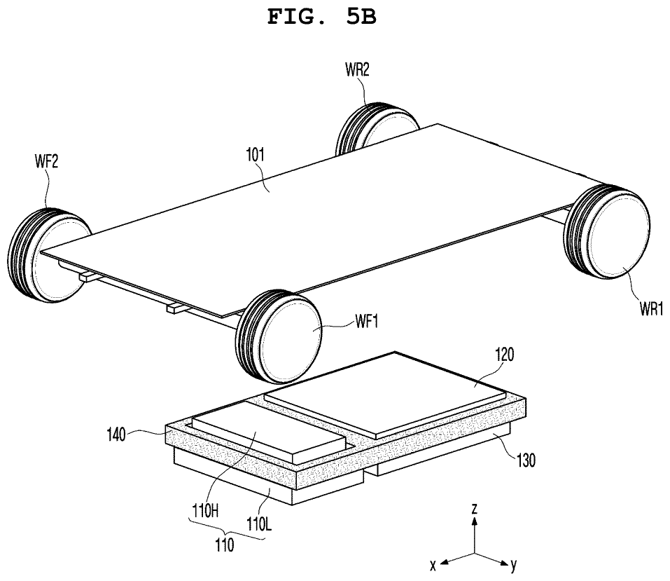

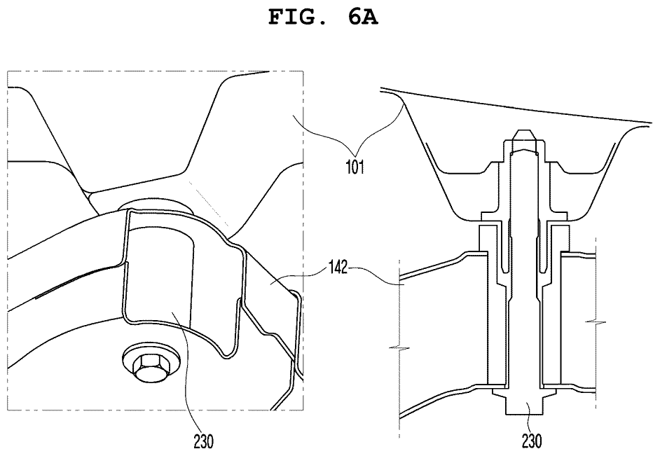

FIG. 1 is a schematic side view of a fuel cell vehicle according to an example embodiment. FIG. 2 is a plan view of the fuel cell vehicle shown in FIG. 1. FIG. 3A is a cross-sectional view taken along line I-I′ shown in FIG. 2, FIG. 3B is a cross-sectional view taken along line II-II′ shown in FIG. 2, and FIG. 3C is a cross-sectional view taken along line III-III′ shown in FIG. 2. FIG. 4A is an exploded perspective view of a fuel cell unit 110, a hydrogen tank 120, and a battery 130, and FIG. 4B is a coupled perspective view of the fuel cell unit 110, the hydrogen tank 120, and the battery 130. FIG. 5A is a bottom perspective view of a vehicle body 101 and a frame module before the vehicle body 101 and the frame module are coupled to each other, and FIG. 5B is a top perspective view of the vehicle body 101 and the frame module before the vehicle body 101 and the frame module are coupled to each other.

The fuel cell vehicle 100 according to the example embodiment may include a vehicle body 101, front wheels WF1 and WF2, rear wheels WR1 and WR2, a front-wheel suspension FS, a rear-wheel suspension RS, a front-wheel power electric (PE) part FPE, a rear-wheel PE part RPE, a fuel cell unit 110, a hydrogen tank 120, and a battery 130. In addition, the fuel cell vehicle 100 according to the example embodiment may further include a frame 140. In addition, the fuel cell vehicle 100 according to the example embodiment may further include an under-cover 150.

The front-wheel PE part FPE is a part, which is located at the front side of the vehicle and in which PE components of the vehicle, such as a motor, a reducer, and an inverter, are disposed. At least a portion of the front-wheel PE part FPE may overlap the front-wheel suspension FS in a vertical direction. The rear-wheel PE part RPE is a part, which is located at the rear side of the vehicle and in which PE components of the vehicle are disposed. At least a portion of the rear-wheel PE part RPE may overlap the rear-wheel suspension RS in the vertical direction.

According to the example embodiment, the fuel cell unit 110, the hydrogen tank 120, and the battery 130 may be disposed between the front wheels WF1 and WF2 and the rear wheels WR1 and WR2. Hereinafter, the area in which the fuel cell unit 110, the hydrogen tank 120, and the battery 130 are disposed will be referred to as a hydrogen area HA. The hydrogen area HA may be located in a central area CA between the front wheels WF1 and WF2 and the rear wheels WR1 and WR2. For example, when the fuel cell vehicle is a passenger vehicle, the central area CA corresponds to a passenger compartment, and when the fuel cell vehicle is a commercial vehicle such as a van or a light truck, the central area CA corresponds to an indoor space in which a driver seat and cargo are loaded.

In addition, the hydrogen area HA may be located between the front-wheel suspension FS and the rear-wheel suspension RS or may be located between the front-wheel PE part FPE and the rear-wheel PE part RPE.

In addition, the hydrogen area HA may be located between the front-wheel suspension FS and the rear-wheel PE part RPE or may be located between the front-wheel PE part FPE and the rear-wheel suspension RS.

According to the example embodiment, at least a portion of the hydrogen area HA may overlap the passenger compartment or the cargo loading space of the vehicle in the vertical direction. If the fuel cell vehicle 100 is a passenger vehicle, the hydrogen area HA may overlap the passenger compartment SI of the vehicle in the vertical direction, as shown in FIG. 1.

The fuel cell unit 110 may include a fuel cell, a junction box (or a high-voltage junction box), and a power control unit.

The unit fuel may include one or more unit fuel cells stacked in at least one of the vertical direction or the horizontal direction (e.g., the x-axis direction and the y-axis direction).

The unit fuel cell may be a polymer electrolyte membrane fuel cell or a proton exchange membrane fuel cell (PEMFC), which has been considered as a power source for driving vehicles. However, the example embodiments are not limited to any specific configuration or external appearance of the unit fuel cell.

The unit fuel cell included in the fuel cell may include end plates (or pressing plates or compression plates), a current collector, and a cell stack.

The cell stack may include a plurality of unit cells, which are stacked in the horizontal direction. Several tens to several hundreds of unit cells, e.g., 100 to 400 unit cells, may be stacked to form the cell stack.

Each unit cell may generate 0.6 volts to 1.0 volts of electricity, on average 0.7 volts of electricity. Thus, the number of unit fuel cells included in the fuel cell and the number of the plurality of unit cells included in the cell stack of the unit fuel cell may be determined depending on the intensity of the power to be supplied from the fuel cell to a load. The term “load” herein may refer to a part that uses (e.g., requires) power in the fuel cell vehicle 100.

The end plates may be disposed at respective ends of the cell stack, and may support and couple (e.g., fix) the plurality of unit cells. In an example embodiment, the first end plate may be disposed at one of the two opposite ends of the cell stack, and the second end plate may be disposed at the other of the two opposite ends of the cell stack.

In addition, the fuel cell may further include a clamping member. For example, in each unit fuel cell, the clamping member serves to couple (e.g., clamp) the plurality of unit cells together with the end plates in the horizontal direction.

The junction box may be disposed near the fuel cell (e.g., above the fuel cell). The junction box serves to distribute power generated in the cell stack of the fuel cell. For example, the junction box may include fuses and relays to control components of peripheral auxiliary devices (e.g., balance-of-plant (BOP)) assisting in the operation of the fuel cell.

The power control unit serves to boost the output voltage of the fuel cell. Similar to the junction box, the power control unit may be disposed near the fuel cell. The example embodiments are not limited to any specific positions of the junction box and the power control unit. For example, the power control unit may include a high-voltage boosting-type DC/DC converter (or a fuel cell DC/DC converter (FDC)).

The hydrogen tank 120 serves to store hydrogen used (e.g., required) to generate power from the fuel cell unit 110, and may have an irregular shape, for example, a serpentine shape.

The battery 130 serves to store (e.g., finally) boosted voltage output from the power control unit and supply power used (e.g., required) for the load.

According to the example embodiment, the fuel cell unit 110, the hydrogen tank 120, and the battery 130 may be disposed above a ramp angle line RAL and a ground line GL in consideration of the weight of the vehicle. Here, the ground line GL is a line indicating a surface, with which the wheels WR1, WR2, WF1, and WF2 of the vehicle are in contact, on a two-dimensional drawing. The ground line GL may correspond to a line connecting the grounding point of the front wheels WF1 and WF2 and the grounding point of the rear wheels WR1 and WR2 in consideration of the weight of the vehicle. The gap between the vehicle and the ground line GL is referred to as a ground clearance line (GCL), and (e.g., all of) the components of the vehicle are (e.g., safely) disposed above the GCL.

Dynamic ground clearance is applied during travel of the vehicle. While the vehicle travels on a ramp, a ramp angle is calculated so that the center portion of the wheelbase (e.g., distance between the front axle and the rear axle) of the bottom (e.g., floor) of the vehicle does not touch the ramp, thereby preventing damage to the side sill of the vehicle body, the cross member, the floor, the exhaust system, and parts located at the center of the wheelbase of the bottom of the vehicle.

As shown, if the battery 130 is disposed below the hydrogen tank 120, the fuel cell unit 110 and the battery 130 may be disposed above the ground line GL by a fourth height ZA.

In the vertical direction, the fuel cell unit 110 has a second height Z2, the hydrogen tank 120 has a sixth height Z6, and the battery 130 has a fifth height Z5.

According to the example embodiment, the under-cover 150 may be further disposed below the fuel cell unit 110, the hydrogen tank 120, and the battery 130 in consideration of the aerodynamics of the lower part of the vehicle, thereby making the lower part of the vehicle flat. In the example embodiment, the under-cover 150 may be disposed above the ramp angle line RAL, and may be disposed above the ground line GL by a third height Z3 in consideration of the weight of the vehicle.

In addition, the fuel cell unit 110, the hydrogen tank 120, and the battery 130 may be disposed below a floor CF of the vehicle. Accordingly, as the second, fifth, and sixth heights Z2, Z5, and Z6 decrease, the residential height H of the indoor space increases, and thus the size of the passenger compartment or the size of the cargo loading space of the truck may increase.

In addition, the fuel cell unit 110, the hydrogen tank 120, and the battery 130 may be modularized together with the frame 140 to form a frame module. As shown in FIGS. 5A and 5B, the frame module may be (e.g., integrally) coupled to the vehicle body 101.

The frame 140 may include a framework 142 and first and second through-holes AS1 and AS2. The first and second through-holes AS1 and AS2 may be disposed within the framework 142 so as to be adjacent to each other in a first direction (e.g., the x-axis direction) in which the vehicle travels.

At least a portion of the fuel cell unit 110 may be located in the first through-hole AS1, and at least a portion of the hydrogen tank 120 and at least a portion of the battery 130 may overlap the second through-hole AS2 in a second direction (e.g., the z-axis direction) intersecting the first direction.

In the example embodiment, the first through-hole AS1 may be located closer to the front side of the vehicle than the second through-hole AS2.

According to the example embodiment, as shown in FIG. 2, the front-wheel suspension FS and the hydrogen area HA (e.g., the framework 142) may be disposed so as to be spaced apart from each other by a distance X1 greater than a “forward collision push-back distance” in the first direction. Herein, the “forward collision push-back distance” may provide (e.g., mean) the movement distance of the front-wheel suspension FS and the front-wheel PE part FPE in the event of vehicle collision.

In addition, according to the example embodiment, as shown in FIG. 2, the rear-wheel suspension RS and the hydrogen area HA (e.g., the framework 142) may be disposed so as to be spaced apart from each other by a distance X2 greater than a “rear collision push-back distance” in the first direction. Herein, the “rear collision push-back distance” may provide (e.g., mean) the movement distance of the rear-wheel suspension RS and the rear-wheel PE part RPE in the event of vehicle collision.

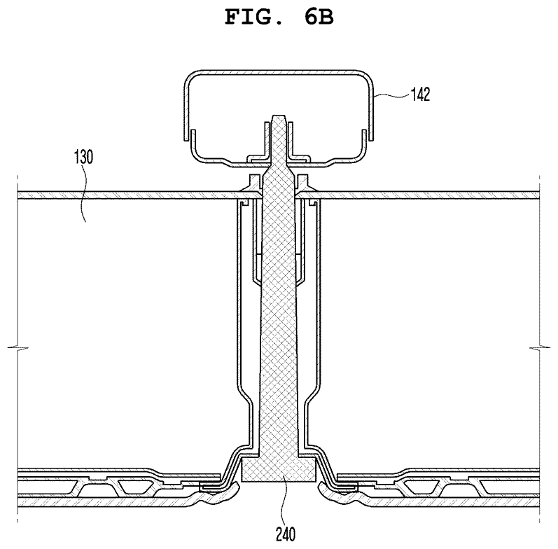

FIG. 6A is a coupled perspective view of the frame 140 and the vehicle body 101 according to an example embodiment, and FIG. 6B is a coupled cross-sectional view of the battery 130 and the frame 140 according to an example embodiment.

According to the example embodiment, the fuel cell unit 110, the hydrogen tank 120, and the battery 130 may be mounted to the frame 140, and the frame 140 may be coupled to the vehicle body 101. According to the example embodiment, the fuel cell unit 110, the hydrogen tank 120, and the battery 130 may be coupled to the vehicle body 101 through the frame 140.

The frame 140 may be coupled to the vehicle body 101 in various manners. For example, the fuel cell unit 110, the hydrogen tank 120, and the battery 130 may be coupled to the frame 140 in various manners, such as a male-female coupling manner or a fitting manner. However, the example embodiments are not limited to any specific coupling method of the above components.

The fuel cell vehicle 100 according to the example embodiment may further include first and second fixing parts.

The first fixing part serves to fix the framework 142 to the vehicle body 101. For example, as exemplarily shown in FIG. 6A, the framework 142 may be fixed to the vehicle body 101 using the first fixing part such as a bolt 230. The framework 142 may be bolt-mounted to the vehicle body 101 in a suspension mounting manner.

The second fixing part may fix the fuel cell unit 110, the hydrogen tank 120, and the battery 130 to the framework 142. For example, as exemplarily shown in FIG. 6B, the battery 130 may be fixed to the framework 142 using the second fixing part such as a bolt 240. Similarly, the fuel cell unit 110 and the hydrogen tank 120 may also be fixed to the framework 142. In the example embodiment, the fuel cell unit 110, the hydrogen tank 120, and the battery 130 may be bolt-mounted to the framework 142.

Referring to FIG. 2, the fuel cell vehicle 100, according to the example embodiment, may further include a pair of side members RH and LH. The pair of side members RH and LH may be disposed at the lower part of the vehicle 100 while extending in the first direction from the front side of the vehicle 100 to the rear side of the vehicle 100 and facing each other in a third direction (e.g., the y-axis direction) intersecting each of the first and second directions, thereby forming the skeleton of the vehicle 100.

As shown in FIG. 3B, the fuel cell unit 110 may include an upper portion 110H and a lower portion 110L.

The upper portion 110H of the fuel cell unit 110 may be located between the pair of side members RH and LH, and the lower portion 110L of the fuel cell unit 110 may be located beneath the upper portion 110H and may have a larger width in the third direction (e.g., the y-axis direction) than the upper portion 110H.

A width Y3 of the upper portion 110H in the third direction may be less than a side member span Y1 between the side members RH and LH, and a width Y4 of the lower portion 110L in the third direction may be greater than the side member span Y1 and less than a side sill span Y2. In the example embodiment, the side member span Y1 is a spacing distance between the pair of side members RH and LH in the third direction, and, in addition, the side sill span Y2 is a spacing distance between a pair of side sills RHS and LHS in the third direction.

In the example embodiment, the pair of side sills RHS and LHS provides (e.g., means) both side ends of the floor CF, and corresponds to components with which lower portions of doors come into contact.

At least a portion of one of the hydrogen tank 120 and the battery 130 may be disposed between the pair of side members RH and LH, and the other of the hydrogen tank 120 and the battery 130 may be disposed below one of the hydrogen tank 120 and the battery 130.

In an example embodiment, as shown in the drawings, the hydrogen tank 120 may be disposed above the battery 130. In another example embodiment (e.g., different than the configuration shown in the drawings), the battery 130 may be disposed above the hydrogen tank 120.

Thus, among the hydrogen tank 120 and the battery 130, the width of one component (e.g., the hydrogen tank 120) in the third direction (e.g., the y-axis direction), which is located at a higher position, may be less than the width of the other component (e.g., the battery 130) in the third direction, which is located at a lower position.

According to the example embodiment, among the hydrogen tank 120 and the battery 130, the length of at least a portion of one component (e.g., the hydrogen tank 120) in the third direction, which is located at a higher position, may be less than the side member span Y1.

In addition, among the hydrogen tank 120 and the battery 130, the length of the other component (e.g., the battery 130) in the third direction, which is located at a lower position, may be less than the side sill span Y2.

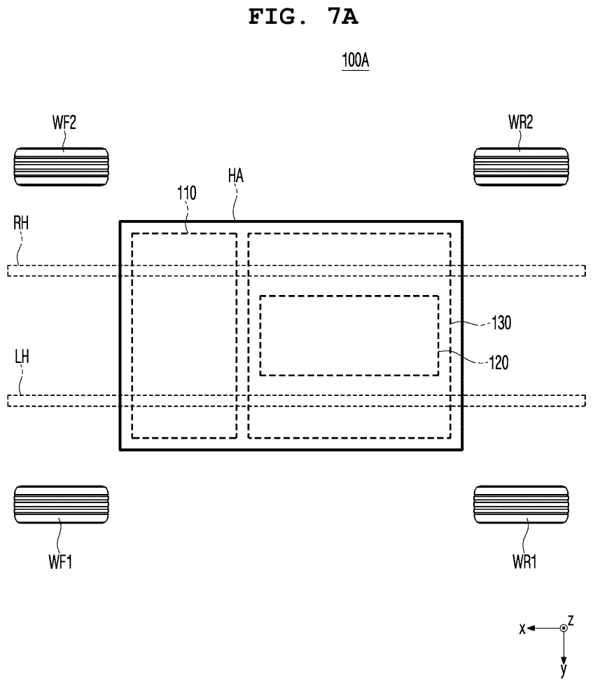

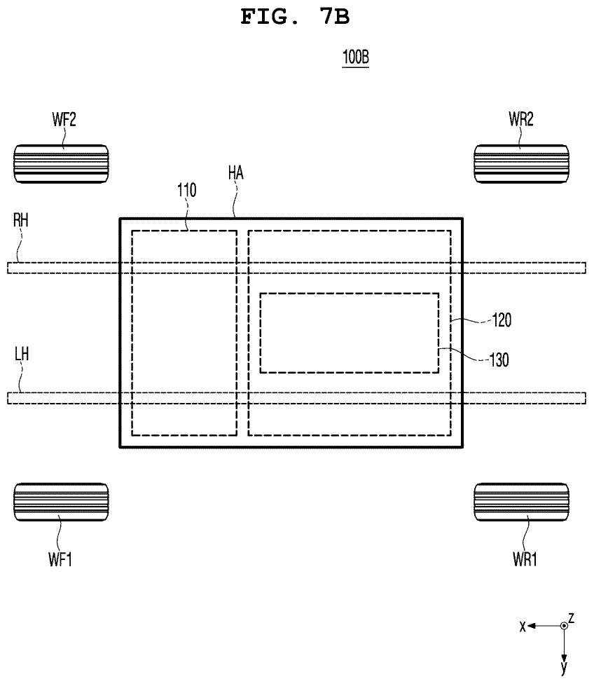

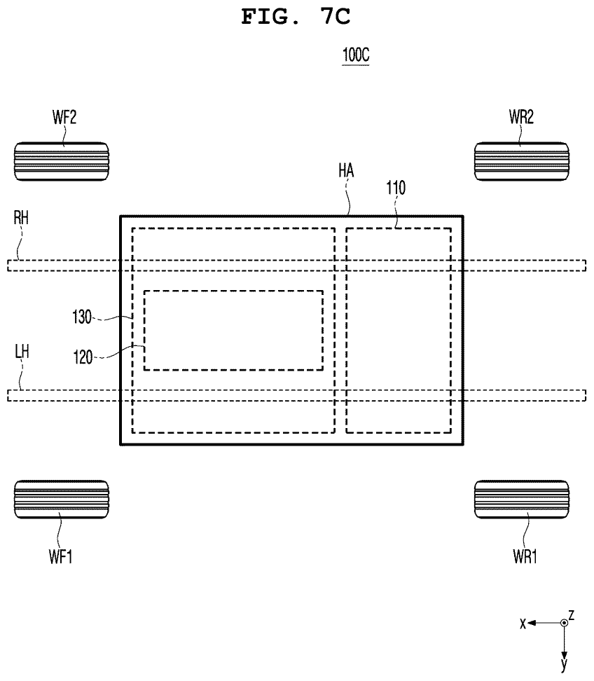

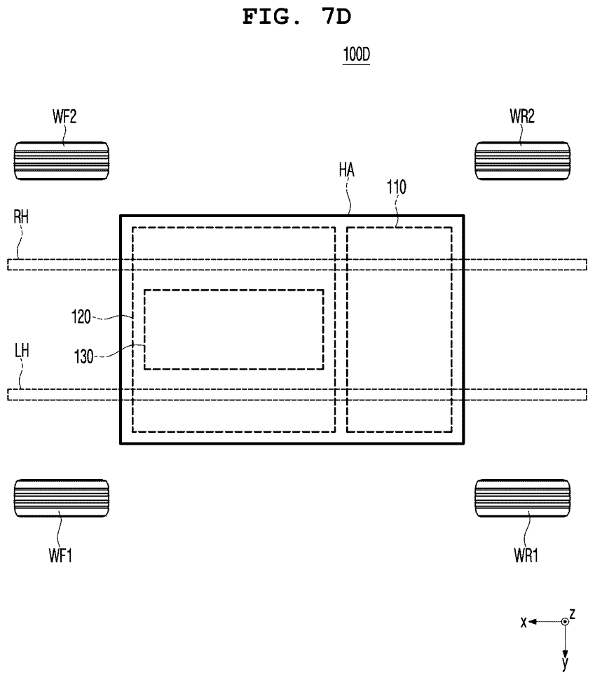

FIG. 7A is a bottom view of an embodiment 100A of the fuel cell vehicle 100 shown in FIG. 1, FIG. 7B is a bottom view of another embodiment 100B of the fuel cell vehicle 100 shown in FIG. 1, FIG. 7C is a bottom view of still another embodiment 100C of the fuel cell vehicle 100 shown in FIG. 1, and FIG. 7D is a bottom view of yet another embodiment 100D of the fuel cell vehicle 100 shown in FIG. 1.

In order to increase the capacity of the battery 130, the battery 130 may be placed below the hydrogen tank 120, as shown in FIGS. 1, 7A, and 7C.

In addition, if the capacity of the fuel cell unit 110 is increased in accordance with the size of the vehicle, the capacity of the hydrogen tank 120 also is increased. If the hydrogen storage capacity is increased, the hydrogen tank 120 may be placed below the battery 130, as shown in FIGS. 7B and 7D. Thus, the width of the hydrogen tank 120 in the third direction may be increased to the side sill span Y2. According to still another example embodiment, as shown in FIGS. 7C and 7D, in accordance with the vehicle condition, the hydrogen tank 120 and the battery 130 may be disposed at a front position, and the fuel cell unit 110 may be disposed at a rear position.

Hereinafter, a fuel cell vehicle according to a comparative example and the fuel cell vehicle according to the example embodiment will be described through comparison.

It is provided (e.g., assumed) that the fuel cell vehicle according to the comparative example is manufactured using a platform for internal combustion engine vehicles. Thus, because a high-voltage battery is disposed in a trunk compartment, which is located above a rear-wheel motor, there is a limitation in realizing three-row seat configuration, which is one of the advantages of sport utility vehicles (SUVs), which may lead to degradation in performance of the vehicle, efficiency of use of a passenger compartment, and marketability of the vehicle.

In the case of the conventional fuel cell vehicle of the comparative example, which uses the platform for internal combustion engine rear-wheel-drive vehicles, a fuel cell and parts associated therewith are mounted in an engine compartment, and an electric motor and a high-voltage battery are disposed at the rear side of the vehicle, so that the load is almost equally distributed to the front side and the rear side of the vehicle. However, compared to an electric vehicle, the center of gravity of the fuel cell vehicle according to the comparative example is positioned high. The reason for this is that, in the fuel cell vehicle according to the comparative example, the fuel cell, which is the heaviest component, is disposed above the front-wheel PE part, which includes a motor, a reducer, and an inverter, in the engine compartment, and the high-voltage battery is disposed above the rear-wheel PE part in the trunk compartment. Further, in the case of the fuel cell vehicle according to the comparative example, because there is no space in which to mount the motor and the reducer in the engine compartment, there is a limitation in building an all-wheel-drive (AWD) system. In addition, a hydrogen tank is provided in a T shape on the under-floor utilizing the positions of the tunnel part and the fuel tank of the conventional internal combustion engine. However, the hydrogen tank protrudes like the tunnel part protruding toward the rear drive shaft of the rear-wheel-drive vehicle, thus inconveniencing the user.

When a fuel cell system including a fuel cell, a battery, and a hydrogen tank is mounted in an electric vehicle, the electric vehicle-dedicated platform may not have enough space for mounting of the fuel cell system because the size of the power electric (PE) space (e.g., the PE compartment), which corresponds to the engine compartment of the fuel cell vehicle according to the comparative example, is reduced. For example, the motor, the reducer, and the inverter are disposed in the PE compartment of the electric vehicle, and a part of a heater ventilated air conditioning (HVAC) system, which includes a heater, a ventilation device, and an air conditioner, protrudes toward the PE compartment in order to reduce the extent to which the HVAC system protrudes toward the passenger compartment. As such, because the PE compartment of the electric vehicle may be narrow compared to the internal combustion engine vehicle, it may be challenging to apply the fuel cell system to the electric vehicle. If the size of the PE compartment of the electric vehicle is increased in order to mount the fuel cell system therein, it may be challenging to implement short-overhang design of the PE compartment of the electric vehicle, which is reduced in size due to elimination of the engine, and the amount of change in structure of the vehicle increases, leading to increase in manufacturing cost.

In contrast, the fuel cell vehicle 100 (100A, 100B, 100C, and 100D) according to the example embodiment, the hydrogen area HA in which the fuel cell unit 110, the hydrogen tank 120, and the battery 130 are disposed corresponds to an area in which the high-voltage battery of the electric vehicle is disposed. Thus, the fuel cell vehicle according to the example embodiment may be implemented using the electric vehicle-dedicated platform, thereby solving the above problems with the fuel cell vehicle according to the comparative example implemented using the platform for internal combustion engine vehicles. Further, according to the example embodiment, because the position at which the frame 140 is disposed is the position at which the battery of the electric vehicle is disposed, a frame to which the high-voltage battery of the electric vehicle is mounted is utilized for mounting of the fuel cell unit 110, the hydrogen tank 120, and the battery 130. Thus, some components may be (e.g., commonly) used and simplified, leading to reduction in investment cost and manufacturing cost and improvement of assemblability.

In the case of the electric vehicle, a plurality of reinforcement members is provided on the floor of the vehicle body in order to mount the high-voltage battery. However, when these reinforcement members are mounted on the side sill of the vehicle body, the coupling structure becomes complicated, which adversely affects the mounting rigidity and quality. In contrast, the fuel cell vehicle 100 (100A, 100B, 100C, and 100D) according to the example embodiment, the fuel cell unit 110, the hydrogen tank 120, and the battery 130 are mounted to the frame 140, and the frame 140 is fastened to the vehicle body. Accordingly, it may be possible to increase the rigidity in preparation for side collision, and thus, a large number of reinforcement members may not be used (e.g., required).

Further, the fuel cell unit 110, the hydrogen tank 120, and the battery 130 may be modularized together with the frame 140 to form a frame module, and the frame module may be coupled to the vehicle body 101. Therefore, the assembly process may be simplified, and the investment cost may be reduced.

In addition, since the fuel cell vehicle according to the example embodiment is capable of using the electric vehicle-dedicated platform without modifying the same, the fuel cell unit 110 and the battery 130, which are the heaviest components, are disposed at the lower side of the vehicle. Thus, compared to the aforementioned comparative example, the center of gravity of the vehicle is positioned low, distribution of load to the front side and the rear side of the vehicle is improved, the three-row seat configuration is provided (e.g., realized), and the size of the passenger compartment SI is increased. As a result, the marketability of the vehicle 100 (100A, 100B, 100C, and 100D) may be improved. In addition, it may be possible to provide (e.g., realize) three-row seat configuration for sport utility vehicles (SUVs) and four-row seat configuration for multi-purpose vehicles (MPVs). Further, if the fuel cell vehicle according to the example embodiment is a van or the like, the cargo loading capacity may increase.

In addition, according to the example embodiment, the hydrogen area HA is disposed below the floor CF in the central area CA, similar to the electric vehicle. Accordingly, compared to the fuel cell vehicle of the comparative example, the center of gravity of the vehicle is positioned low, and thus the driving stability of the vehicle may be improved. Further, like the electric vehicle, the floor CF of the vehicle 100 may be flat.

For example, if the fuel cell unit 110 weighs about 90 kg, the two hydrogen tanks 120 weigh about 80 kg, the battery 130 weighs about 300 kg, the frame 140 weighs about 80 kg, and the wheel base has a length of 3500 mm, it may be possible to almost equally distribute load to the front side and the rear side of the fuel cell vehicle 100 (100A and 100B) and to allow the center of gravity of the vehicle to be kept low. Accordingly, when the example embodiment is applied to a vehicle having a high overall height, the driving stability thereof may be increased. If the fuel cell system is mounted in a vehicle having a low overall height, the ground clearance may be increased. However, according to the example embodiment, it may be possible to lower the center of gravity, thereby improving the driving stability of the vehicle.

In addition, according to the example embodiment, the size of the engine compartment is small, like the existing electric vehicle, and thus the size of the passenger compartment may be kept large. Hence, similar to the existing electric vehicle, it may be possible to implement short-front-overhang, and thus the freedom of design may increase. In addition, when an in-wheel motor is employed, the space for the front-wheel PE part FPE may be further narrowed. However, according to the example embodiment, it may be possible to implement a fuel cell vehicle without greatly modifying the front-wheel PE part FPE of the electric vehicle.

The fuel cell vehicle 100 according to the example embodiment described herein may be applied to aircraft, ships, stationary power generation systems, and/or the like=, but the disclosure is not limited thereto.

As may be provided from the above description, since a fuel cell vehicle according to the example embodiment is capable of using an electric vehicle-dedicated platform without modifying the same, some components may be (e.g., commonly) used and simplified, leading to reduction in investment cost and manufacturing cost and improvement of assemblability. Further, it may be possible to increase the rigidity in preparation for side collision. Further, since a fuel cell unit, a hydrogen tank, and a battery are modularized together with a frame to form a frame module and the frame module is coupled to the vehicle body, the assembly process may be simplified, and the investment cost may be reduced. Furthermore, the size of the passenger compartment may be increased compared to the conventional fuel cell vehicle, and thus the marketability of the vehicle may be improved. Furthermore, when the example embodiment is applied to sport utility vehicles (SUVs) and multi-purpose vehicles (MPVs), cargo loading capacity may increase, and driving stability may be improved. Furthermore, the floor of the vehicle may be flat, like the electric vehicle.

The disclosure is not limited to the above-mentioned effects, and other effects not mentioned herein may be provided from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While the present disclosure has been shown and described with reference to exemplary embodiments thereof, these embodiments are provided for illustrative purposes, and do not restrict the present disclosure, and it may be provided that various changes in form and detail may be made without departing from the example embodiments set forth herein. For example, respective configurations set forth in the example embodiments may be modified and applied. Further, differences in such modifications and applications should be construed as falling within the scope of the present disclosure and the claims herein.

What is claimed is:

1. A fuel cell vehicle, comprising:
a fuel cell unit, a hydrogen tank, and a battery disposed in a hydrogen area located between front wheels and rear wheels; and
a frame coupled to a vehicle body, the frame being configured to allow the fuel cell unit, the hydrogen tank, and the battery to be mounted thereto.

2. The fuel cell vehicle according to claim 1, wherein the fuel cell unit, the hydrogen tank, and the battery are disposed above a ramp angle line.

3. The fuel cell vehicle according to claim 1, further comprising an under-cover disposed below the fuel cell unit, the hydrogen tank, and the battery.

4. The fuel cell vehicle according to claim 1, wherein the fuel cell unit, the hydrogen tank, and the battery are modularized with the frame to form a frame module, and
wherein the frame module is integrally coupled to the vehicle body.

5. The fuel cell vehicle according to claim 1, wherein at least a portion of the hydrogen area overlaps an indoor space or a cargo loading space of the vehicle in a vertical direction.

6. The fuel cell vehicle according to claim 1, wherein the frame includes a framework having first and second through-holes formed therein, wherein the first and second through-holes are adjacent to each other in a first direction in which the vehicle travels, and
wherein at least a portion of the fuel cell unit is located in the first through-hole, and at least a portion of the hydrogen tank and at least a portion of the battery overlap the second through-hole in a second direction intersecting the first direction.

7. The fuel cell vehicle according to claim 6, further comprising:
a first fixing part configured to fix the framework to the vehicle body; and
a second fixing part configured to fix the fuel cell unit, the hydrogen tank, and the battery to the framework.

8. The fuel cell vehicle according to claim 6, wherein the hydrogen area is located between a front-wheel suspension and a rear-wheel suspension.

9. The fuel cell vehicle according to claim 8, wherein the hydrogen area is disposed between a front-wheel power electric (PE) part and a rear-wheel PE part.

10. The fuel cell vehicle according to claim 9,
wherein the front-wheel suspension and the framework are disposed so as to be spaced apart from each other by a distance greater than a forward collision push-back distance in the first direction, and
wherein the forward collision push-back distance corresponds to a movement distance of the front-wheel suspension and the front-wheel PE part in event of vehicle collision.

11. The fuel cell vehicle according to claim 9,
wherein the rear-wheel suspension and the framework are disposed so as to be spaced apart from each other by a distance greater than a rear collision push-back distance in the first direction, and
wherein the rear collision push-back distance corresponds to a movement distance of the rear-wheel suspension and the rear-wheel PE part in event of vehicle collision.

12. The fuel cell vehicle according to claim 6, wherein the first through-hole is located closer to a front side of the vehicle than the second through-hole.

13. The fuel cell vehicle according to claim 6, further comprising a pair of side members extending in the first direction and facing each other in a third direction intersecting each of the first direction and the second direction,
wherein the fuel cell unit includes:
an upper portion located between the pair of side members; and
a lower portion located under the upper portion, the lower portion having a larger width in the third direction than the upper portion.

14. The fuel cell vehicle according to claim 13, wherein the hydrogen tank is disposed above the battery.

15. The fuel cell vehicle according to claim 13, wherein the battery is disposed above the hydrogen tank.

16. The fuel cell vehicle according to claim 13, wherein at least a portion of one of the hydrogen tank and the battery is disposed between the pair of side members,
wherein a remaining one of the hydrogen tank and the battery is disposed under the one of the hydrogen tank and the battery, and
wherein a width of the one of the hydrogen tank and the battery in the third direction is smaller than a width of the remaining one of the hydrogen tank and the battery in the third direction.

17. The fuel cell vehicle according to claim 16, wherein a length of at least a portion of the one of the hydrogen tank and the battery in the third direction is less than a spacing distance between the pair of side members in the third direction.

18. The fuel cell vehicle according to claim 16, wherein a length of the remaining one of the hydrogen tank and the battery in the third direction is greater than a spacing distance between the pair of side members in the third direction and less than a spacing distance between a pair of side sills in the third direction.
